(19) United States
(12) Patent Application Publication
(10) Pub. No.: US 2023/0066151 A1
(43) Pub. Date: Mar. 2, 2023

(54) HIGH-RIGIDITY IRON-BASED ALLOY AND METHOD OF MANUFACTURING THE SAME

(71) Applicant: TOYOTA JIDOSHA KABUSHIKI KAISHA, Toyota-shi (JP)

(72) Inventors: Yuuki KAMO, Okazaki-shi (JP); Chikatoshi MAEDA, Toyota-shi (JP)

(73) Assignee: TOYOTA JIDOSHA KABUSHIKI KAISHA, Toyota-shi (JP)

(21) Appl. No.: 17/876,906

(22) Filed: Jul. 29, 2022

(30) Foreign Application Priority Data
Aug. 27, 2021 (JP) 2021-138816

(51) Int. Cl. B22F 1/12; B22F 10/28; B33Y 10/00; B33Y 70/00

(52) U.S. Cl. CPC B22F 1/12; B22F 10/28; B33Y 10/00; B33Y 70/00; B22F 2301/35; B22F 2304/10; B22F 2302/05

(57) ABSTRACT

A high-rigidity iron-based alloy contains a matrix made of iron or a ferroalloy, and titanium boride dispersed in the matrix, in which an equivalent circle average particle diameter by an SEM image of the titanium boride is within a specific range.

### CROSS-REFERENCE TO RELATED APPLICATION

This application claims priority to Japanese Patent Application No. 2021-138816 filed on Aug. 27, 2021, incorporated herein by reference in its entirety.

### BACKGROUND

### 1. Technical Field

The present disclosure relates to a high-rigidity iron-based alloy containing a matrix made of iron or a ferroalloy, and fine titanium boride dispersed in the matrix, and a method of manufacturing the high-rigidity iron-based alloy by a lamination molding method.

### 2. Description of Related Art

Currently, steel or a ferroalloy is the most widely used as a structural metal material. The metal material shows extremely various structural changes due to the alloy element addition or the heat treatment, and it is possible to control a wide range of mechanical properties, such as strength and ductility.

However, since the rigidity that is needed in the design of an actual component is a value peculiar to a substance that is directly related to a bonding force between atoms, it is considered difficult to significantly improve the rigidity.

Under such circumstances, research and development has been performed in which compound particles, such as boride having a high Young's modulus, are dispersed with the intention of increasing the rigidity in the iron or the ferroalloy. For example, Japanese Unexamined Patent Application Publication No. 2002-285303 (JP 2002-285303 A) discloses a high-rigidity iron-based alloy containing a matrix made of iron or a ferroalloy, and at least one or more of boride mainly formed of a group 4A element dispersed in the matrix and having a particle diameter of 1 μm to 100 μm, in which the boride mainly formed of the group 4A element is thermodynamically stable in the matrix.

### SUMMARY

However, for example, in the high-rigidity iron-based alloy disclosed in JP 2002-285303 A, there is a possibility that coarse boride having high hardness dispersed in a matrix made of iron or a ferroalloy damages a cutting tool during machining, such as cutting.

Therefore, the present disclosure provides a high-rigidity iron-based alloy that can be easily subjected to machining, and a method of manufacturing the same.

Examples of factors that cause the coarse boride in the high-rigidity iron-based alloy include that it is difficult to mix powder of the iron or the ferroalloy constitutes the matrix of the high-rigidity iron-based alloy and powder of the boride having a small particle diameter, for example, the boride having an average particle diameter of 1 μm or less to obtain a homogeneous mixture, further, originally fine borides aggregate and are bonded with each other and become larger when the powder mixture is dissolved (fused).

As a result of various studies on means for solving the above-described problems, the present inventors have found that boride is generated in a matrix made of iron or a ferroalloy and a thermal history is controlled such that the generated boride does not grow excessively, so that the boride having a small particle diameter in the matrix can be generated.

Therefore, as a result of further studies, the present inventors have found that powder of an iron-titanium intermetallic compound (FeTi), powder of an iron-boron intermetallic compound (FeB), and optionally iron (Fe)-based powder are mixed to obtain mixed powder, and the obtained mixed powder is treated by a lamination molding method accompanied by laser irradiation to generate titanium boride by an in-situ reaction, so that the high-rigidity iron-based alloy containing the matrix made of the iron and the ferroalloy, and the fine titanium boride dispersed in the matrix can be manufactured, and have completed the present disclosure.

That is, the gist of the present disclosure is as follows.

(1) A high-rigidity iron-based alloy contains a matrix made of iron or a ferroalloy, and titanium boride dispersed in the matrix. An equivalent circle average particle diameter by an SEM image of the titanium boride is 0.2 μm to 0.6 μm.

(2) The high-rigidity iron-based alloy according to (1), in which the equivalent circle average particle diameter by the SEM image of the titanium boride may be 0.2 μm to 0.4 μm.

(3) A method of manufacturing a high-rigidity iron-based alloy includes (i) a step of mixing powder of an iron-titanium intermetallic compound and powder of an iron-boron intermetallic compound to obtain mixed powder. The method includes (ii) a step of treating the mixed powder obtained in the step of (i) by a lamination molding method accompanied by laser irradiation to obtain a high-rigidity iron-based alloy.

(4) The method according to (3), in which the step of (i) may include (i-2) a step of mixing the powder of the iron-titanium intermetallic compound, the powder of the iron-boron intermetallic compound, and iron-based powder to obtain mixed powder.

(5) The method according to (3) or (4), in which, in the step of (ii), a cooling rate during lamination molding may be 10,000 K/sec or more.

(6) The method according to any one of (3) to (5), in which, in the step of (ii), the lamination molding method accompanied by the laser irradiation may be a PBF method.

(7) The method according to any one of (3) to (5), in which, in the step of (ii), the lamination molding method accompanied by the laser irradiation may be a DED method, and iron from a substrate for manufacturing the high-rigidity iron-based alloy may be penetrated into an iron-based alloy.

The present disclosure provides the high-rigidity iron-based alloy that can be easily subjected to machining, and a method of manufacturing the same.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an example of a device that performs a lamination molding method by a PBF method;

FIG. 2 is a schematic diagram showing an example of a device that performs a lamination molding method by a DED method;

FIG. 3 is a schematic diagram of test pieces obtained in Comparative Example 1 and Examples 1 to 3;

FIG. 4 is an SEM image of Comparative Example 1;

FIG. 5 is an SEM image of Example 1;

FIG. 6 is an SEM image of Example 2; and

FIG. 7 is an SEM image of Example 3.

### DETAILED DESCRIPTION OF EMBODIMENTS

In the following, a preferred embodiment of the present disclosure will be described in detail.

In the present specification, the features of the present disclosure will be described with reference to the drawings as appropriate. In the drawings, the dimension and shape of each part are exaggerated for clarity, and the actual dimension and shape are not accurately depicted. Therefore, the technical scope of the present disclosure is not limited to the dimension and shape of each part shown in these drawings. Note that a high-rigidity iron-based alloy according to the embodiment of the present disclosure and a method of manufacturing the same are not limited to the following embodiment, and can be performed in various forms with modifications, improvements, and the like that can be made by those skilled in the art within a range of not deviating the gist of the present disclosure.

The present disclosure relates to a high-rigidity iron-based alloy containing a matrix made of iron or a ferroalloy, and titanium boride dispersed in the matrix, in which a particle diameter of the titanium boride is within a specific range.

Here, the high-rigidity iron-based alloy according to the embodiment of the present disclosure has a structure in which fine titanium boride is uniformly dispersed in the matrix made of the iron or the ferroalloy.

As the ferroalloy constituting the matrix of the high-rigidity iron-based alloy according to the embodiment of the present disclosure, a wide range of ferroalloys, such as a ferrite type, an austenitic type, and a martensitic type, can be used, and a ferroalloy having a carbon content of 0.1% by weight or less is preferable from a viewpoint of thermodynamic stability.

In the high-rigidity iron-based alloy according to the embodiment of the present disclosure, an equivalent circle average particle diameter of crystal grains in an IPF image of the matrix made of the iron or the ferroalloy is not limited, but is usually more than 1 μm, preferably more than 1 μm to 5 μm.

A method of measuring the equivalent circle average particle diameter of the crystal grains by the IPF image of the matrix made of the iron or the ferroalloy can be performed by capturing three images of an electron back scattered diffraction pattern (EBSD)-inverse pole figure (IPF) image of the high-rigidity iron-based alloy that is a measurement target, randomly selecting 30 crystal grains in each image, calculating an area for each selected crystal grain, and then calculating a circle equivalent diameter from the calculated area to finally obtain an addition average value from the calculated circle equivalent diameter.

In a case where the average particle diameter of the crystal grains of the matrix made of the iron or the ferroalloy is within the range described above, the iron-based alloy has high strength and high rigidity.

The titanium boride uniformly dispersed in the matrix made of the iron or the ferroalloy of the high-rigidity iron-based alloy according to the embodiment of the present disclosure is diboride represented by a chemical formula TiB₂.

The titanium boride contained in the high-rigidity iron-based alloy according to the embodiment of the present disclosure has a regular crystal structure and is a compound in which constituent atoms are strongly bonded. Therefore, a Young's modulus in which the bonding force is directly reflected is extremely high. In addition, since the titanium boride is thermodynamically stable in the ferroalloy, a crystallographic change, such as invasion and substitution of heteroatoms, or formation of other complex compounds, due to the reaction of the titanium boride with the matrix made of the iron or the ferroalloy does not occur. As a result, the titanium boride maintains the strong bonding force even in the ferroalloy, is not changed with a high Young's modulus, and can fully exhibit an excellent characteristic as a reinforced particle that contributes to the high rigidity of the iron-based alloy. Therefore, the iron-based alloy according to the embodiment of the present disclosure can have an extremely high Young's modulus.

The average particle diameter of the titanium boride is 0.2 μm to 0.9 μm, preferably 0.2 μm to 0.6 μm, and more preferably 0.2 μm to 0.4 μm as the circle equivalent diameter in accordance with an SEM image.

A method of measuring the equivalent circle average particle diameter of the titanium boride by the SEM image can be performed by capturing three images of an electron backscattered electron (BSE)-SEM image of the high-rigidity iron-based alloy that is the measurement target, randomly selecting 300 particles of titanium boride in each image, calculating an area for each selected titanium boride, and then calculating a circle equivalent diameter from the calculated area to finally obtain an addition average value from the calculated circle equivalent diameter.

In a case where the average particle diameter of the titanium boride is within the range described above, the stress applied to a cutting tool in cutting high hardness titanium boride during processing of the high-rigidity iron-based alloy is dispersed and damaging of the cutting tool is reduced, so that the machinability is improved with maintained high rigidity.

It is preferable that the particle diameter of the titanium boride be uniform. The particle diameter of the titanium boride is not limited. However, for example, in a case where the particles of the titanium boride follow a normal distribution, the particle diameter of 68% of the number of particles of the titanium boride usually is within a range of an average particle diameter ±0.20 μm, preferably an average particle diameter ±0.17 μm.

By aligning the particle diameters of the titanium boride is within the range described above, the stress applied to a cutting tool in cutting high hardness titanium boride during processing of the high-rigidity iron-based alloy is dispersed and damaging of the cutting tool is reduced, so that the machinability is improved with maintained high rigidity.

A content of the titanium boride is usually 3% by weight to 40% by weight, preferably 7% by weight to 35% by weight, with respect to a total weight of the high-rigidity iron-based alloy.

In a case where the content of the titanium boride is within the range described above, the titanium boride can exhibit a sufficient mechanical characteristic, particularly high rigidity, in the high-rigidity iron-based alloy without causing formation of aggregation and combination of the borides.

Therefore, the high-rigidity iron-based alloy according to the embodiment of the present disclosure exhibits a sufficient mechanical characteristic, particularly high rigidity, due to containing the titanium boride, and further, can be easily cut without damaging the cutting tool in a cutting step due to the fineness of the titanium boride.

The high-rigidity iron-based alloy according to the embodiment of the present disclosure may contain, in addition to the titanium boride, one or more other elements, such as nickel, cobalt, chromium, magnesium, molybdenum, carbon, and manganese, and a compound thereof, such as the boride, depending on a component needed in the finally obtained high-rigidity iron-based alloy.

Further, the present disclosure also relates to a method of manufacturing the high-rigidity iron-based alloy according to the embodiment of the present disclosure described above. That is, the present disclosure relates to the method of manufacturing a high-rigidity iron-based alloy, the method including (i) a step of mixing powder of an iron-titanium intermetallic compound and powder of an iron-boron intermetallic compound to obtain mixed powder, and (ii) a step of treating the mixed powder obtained in the step of (i) by a lamination molding method accompanied by laser irradiation to obtain a high-rigidity iron-based alloy.

In the following, each of steps of (i) and (ii) will be described.

(i) Step of Mixing Powder of Iron-Titanium Intermetallic Compound and Powder of Iron-Boron Intermetallic Compound to Obtain Mixed Powder

In the step of (i) according to the embodiment of the present disclosure, the powder of the iron-titanium intermetallic compound and the powder of the iron-boron intermetallic compound are mixed to obtain the mixed powder.

The powder of the iron-titanium intermetallic compound is pulverized powder of an alloy (FeTi) containing iron and titanium.

An average particle diameter of the powder of the iron-titanium intermetallic compound is not limited, but, for example, is usually 25 μm to 200 μm, preferably 45 μm to 140 μm as D50 in a volume-based particle diameter distribution measured by a laser diffraction and scattering method.

In a case where the average particle diameter of the powder of the iron-titanium intermetallic compound is within the range described above, mixing with the powder of the iron-boron intermetallic compound can be easily and uniformly performed.

A composition of the iron-titanium intermetallic compound can be changed depending on an amount of the titanium boride contained in the high-rigidity iron-based alloy to be manufactured, but a weight ratio of the iron to the titanium (Fe:Ti) is usually 80:20 to 25:75, preferably 70:30 to 50:50.

In a case where the composition of the iron-titanium intermetallic compound is within the range described above, a stable iron-titanium intermetallic compound can be obtained, and the amount of the titanium boride described above can be secured in the high-rigidity iron-based alloy finally obtained by the reaction with the iron-boron intermetallic compound.

The powder of the iron-boron intermetallic compound is pulverized powder of an alloy (FeB) containing iron and boron.

An average particle diameter of the powder of the iron-boron intermetallic compound is not limited, but, for example, is usually 25 μm to 200 μm, preferably 45 μm to 140 μm as D50 in a volume-based particle diameter distribution measured by the laser diffraction and scattering method.

In a case where the average particle diameter of the powder of the iron-boron intermetallic compound is within the range described above, mixing with the powder of the iron-titanium intermetallic compound can be easily and uniformly performed.

A composition of the iron-boron intermetallic compound can be changed depending on an amount of the titanium boride contained in the high-rigidity iron-based alloy to be manufactured, but a weight ratio of the iron to the boron (Fe:B) is usually 95:5 to 70:30, preferably 85:15 to 75:25.

In a case where the composition of the iron-boron intermetallic compound is within the range described above, a stable iron-boron intermetallic compound can be obtained, and the amount of the titanium boride described above can be secured in the high-rigidity iron-based alloy finally obtained by the reaction with the iron-titanium intermetallic compound.

Note that the powder of the iron-titanium intermetallic compound and the iron-boron intermetallic compound powder may contain one or more other elements, such as nickel, cobalt, chromium, magnesium, molybdenum, carbon, and manganese, depending on a component needed in the finally obtained high-rigidity iron-based alloy.

A mixing ratio of the powder of the iron-titanium intermetallic compound and the powder of the iron-boron intermetallic compound can be changed depending on the composition of each material and the amount of the titanium boride contained in the high-rigidity iron-based alloy to be manufactured. For example, a weight ratio (FeTi:FeB) of the powder of the iron-titanium intermetallic compound to the powder of the iron-boron intermetallic compound is usually 75:25 to 25:75, preferably 60:40 to 40:60. Alternatively, the mixing ratio of the powder of the iron-titanium intermetallic compound and the powder of the iron-boron intermetallic compound is adjusted such that the weight ratio of the titanium to the boron (Ti:B) is usually 1:1 to 10:1, preferably 1.5:1 to 2.5:1.

In a case where the mixing ratio of the powder of the iron-titanium intermetallic compound and the powder of the iron-boron intermetallic compound is within the range described above, the iron-titanium intermetallic compound and the iron-boron intermetallic compound in the matrix made of the iron or the ferroalloy can be reacted sufficiently, and the amount of the titanium boride described above can be secured in the finally obtained high-rigidity iron-based alloy.

In the mixing of the powder of the iron-titanium intermetallic compound and the powder of the iron-boron intermetallic compound, iron-based powder may be further mixed as a material.

Therefore, the step of (i) according to the embodiment of the present disclosure may include (i-2) a step of mixing the powder of the iron-titanium intermetallic compound, the powder of the iron-boron intermetallic compound, and iron-based powder to obtain mixed powder.

The iron-based powder is not limited, and for example, the pulverized powder of the iron, for example, water atomized iron powder can be used. In addition, the iron-based powder may be powder of an alloy of iron, for example, an alloy of iron and one or more other elements, such as nickel, cobalt, chromium, magnesium, molybdenum, carbon, and manganese.

An average particle diameter of the iron-based powder is not limited, but, for example, is usually 25 μm to 250 μm, preferably 25 μm to 140 μm as D50 in a volume-based particle diameter distribution measured by the laser diffraction and scattering method.

In a case where the average particle diameter of the iron-based powder is within the range described above, the iron-based powder can be easily and uniformly mixed with the powder of the iron-titanium intermetallic compound and the powder of the iron-boron intermetallic compound.

As the iron-based powder, ASC100.29 manufactured by Höganäs can be used, for example.

An amount of the iron-based powder that can be added to the mixed powder is not limited, but is usually 5% by weight to 50% by weight, preferably 15% by weight to 35% by weight, with respect to a total weight of the mixed powder. Alternatively, the amount of the iron-based powder that can be added to the mixed powder is adjusted such that a weight ratio (FeTi+FeB:Fe) of the powder of the iron-titanium intermetallic compound and the powder of the iron-boron intermetallic compound to the iron-based powder is usually 95:5 to 50:50. Alternatively, the amount of the iron-based powder that can be added to the mixed powder is adjusted such that the amount of the titanium boride contained in the high-rigidity iron-based alloy to be manufactured is within the range described above.

By adding the iron-based powder in a step of obtaining the mixed powder, the aggregation and growth of the titanium boride contained in the high-rigidity iron-based alloy to be manufactured are suppressed, the average particle diameter of the titanium boride is further reduced, and the dispersibility is improved.

Note that, in the step of (i) or (i-2), the powder containing one or more other elements, such as nickel, cobalt, chromium, magnesium, molybdenum, carbon, and manganese, may be mixed depending on a component needed in the finally obtained high-rigidity iron-based alloy.

A mixing order and a mixing method of each powder, that is, the powder of the iron-titanium intermetallic compound, the powder of the iron-boron intermetallic compound, optionally the iron-based powder, and optionally the powder containing one or more other elements are not limited, and the powder can be mixed using a mixing unit known in the technical field. For example, in a case where the mixed powder contains the iron-based powder, the powder of the iron-titanium intermetallic compound and the powder of the iron-boron intermetallic compound may be mixed and then mixed with the iron-based powder, the powder of the iron-titanium intermetallic compound and the iron-based powder may be mixed and then mixed with the iron-boron intermetallic compound, the powder of the iron-boron intermetallic compound and the iron-based powder may be mixed and then mixed with the iron-titanium intermetallic compound, or all powder may be mixed at the same time. Examples of the mixing method of each powder include a V-type mixer (V-type powder mixer), a ball mill, and a vibration mill. Note that each powder may be mixed by wet type mixing.

By the step of (i) according to the embodiment of the present disclosure, the mixed powder can be obtained in which the powder of the iron-titanium intermetallic compound, the powder of the iron-boron intermetallic compound, optionally the iron-based powder, and optionally the powder containing one or more other elements are uniformly dispersed. (ii) Step of Treating Mixed Powder Obtained in Step of (i) by Lamination Molding

Method Accompanied by Laser Irradiation to Obtain High-Rigidity Iron-Based Alloy

In the step of (ii), the mixed powder obtained in the step of (i) is treated by the lamination molding method accompanied by the laser irradiation to obtain the high-rigidity iron-based alloy.

In the step of (ii) according to the embodiment of the present disclosure, the lamination molding method accompanied by the laser irradiation is a method in which the mixed powder as a raw material is irradiated with a laser, solely a specific part is dissolved and solidified, and this process is repeated to mold the alloy without using a mold. Note that the laser irradiation may be performed based on slice data converted from 3D data.

In the lamination molding method accompanied by the laser irradiation, rapid heating, convection stirring, and rapid cooling of the mixed powder can be performed.

In the method of manufacturing the iron-based alloy in which the powder of the iron-titanium intermetallic compound and the powder of the iron-boron intermetallic compound are used as the raw material to form the titanium boride in the matrix made of the iron or the ferroalloy, in a case where sintering is used, during a temperature rise and sintering step in sintering the mixed powder, the titanium boride is formed by solid phase diffusion, and then grows. Since the particle further grows as a time during which the particle belongs to an environment in which the particle can grow is longer, in order to the fine titanium boride, it is preferable to shorten the time during which the titanium boride can grow after nucleation of the titanium boride. Therefore, in the present disclosure, by using the lamination molding method accompanied by the laser irradiation in order to form the titanium boride in the matrix made of the iron or the ferroalloy using the powder of the iron-titanium intermetallic compound and the powder of the iron-boron intermetallic compound, the cooling rate after fusing the powder can be increased, that is, the growth time of the particle (crystal) after the nucleation of the titanium boride can be shortened, as a result, the fine titanium boride can be formed.

The lamination molding method accompanied by the laser irradiation includes, for example, a powder bed fusion (PBF) method and a directed energy deposition (DED) method.

The PBF is a method in which the mixed powder is spread, a portion to be molded is irradiated with the laser, fused and solidified, and laminated to mold the alloy.

In the PBF, an alloy precursor fused by the laser irradiation can be rapidly cooled at a rate of usually 10,000 K/sec or more to manufacture the alloy.

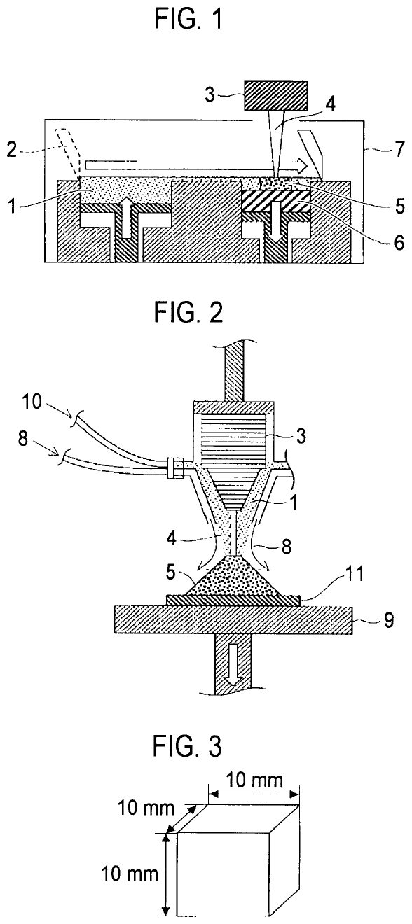

FIG. 1 is a schematic diagram showing an example of a device that performs the lamination molding method by the PBF method. In FIG. 1, in a cover 7 substituted with argon, first, mixed powder 1 loaded in a raw material container is pressed up, and the mixed powder 1 in a pressed-up portion is spread by a blade 2. Next, the mixed powder 1 spread by the blade 2 is irradiated with a laser 4 by a laser generator 3. In a case where the mixed powder 1 is irradiated with the laser 4, the powder in the mixed powder 1 is fusion-bonded to form an iron-based alloy 5 on a base plate 6. By lowering the base plate 6 and repeating these steps (lamination molding), the iron-based alloy 5 is molded.

The DED is a method in which a modeled portion is irradiated with the mixed powder and the laser at the same time, fused, and laminated to be molded, and is also called overlay welding.

In the DED, the alloy precursor fused by the laser irradiation can be rapidly cooled at a rate of usually about 10,000 K/sec to manufacture the alloy.

FIG. 2 is a schematic diagram showing an example of a device that performs the lamination molding method by the DED method. In FIG. 2, the mixed powder 1 and powder-containing gas 10 containing transport gas is released and deposited on a substrate 11, and the mixed powder 1 and the substrate 11 are irradiated with the laser 4 by the laser generator 3 at the same time as the release and deposition of the powder-containing gas 10. In a case where the deposited mixed powder 1 and the substrate 11 are irradiated with the laser 4, the powder in the mixed powder 1 and the substrate 11 are fusion-bonded to form the iron-based alloy 5 on the substrate 11. The iron-based alloy 5 is molded by lowering a modeling platform 9 and repeating these steps (lamination molding). Note that, in this method, shield gas 8 is introduced to scatter the mixed powder, shut off the outside air, and optionally cool the fused alloy precursor. In addition, in this method, as described above, an iron component contained in the substrate 11 can be penetrated into the iron-based alloy 5 by the laser 4. Therefore, by using the iron or the ferroalloy for the substrate 11, instead of mixing the iron-based powder in the step of (i-2) or together with mixing the iron-based powder in the step of (i-2), the iron can be penetrated into the iron-based alloy 5, the average particle diameter can be further reduced for the titanium boride contained in the iron-based alloy 5, and the dispersibility can be improved.

By the step of (ii) according to the embodiment of the present disclosure, the powder of the iron-titanium intermetallic compound, the powder of the iron-boron intermetallic compound, and optionally the iron-based powder generate the fine titanium boride by an in-situ reaction in a state of being uniformly dispersed in the matrix made of the iron or the ferroalloy, as a result, the high-rigidity iron-based alloy having excellent machinability can be obtained.

In the following, some examples of the present disclosure will be described, but the present disclosure is not intended to be limited to such examples.

1. Sample Preparation

### COMPARATIVE EXAMPLE 1

The iron-based alloy was manufactured by the following steps of (i) and (ii).

(i) Step of Mixing Powder of Iron-Titanium Intermetallic Compound and Powder of Iron-Boron Intermetallic Compound to Obtain Mixed Powder

In the step of (i), the pulverized powder containing Fe: 57% by weight and Ti: 43% by weight (particle diameter (D50) by the laser diffraction and scattering method: 45 μm to 140 μm) was used as the powder of the iron-titanium intermetallic compound (FeTi), the pulverized powder containing Fe: 78% by weight and B: 22% by weight (particle diameter (D50) by the laser diffraction and scattering method: 45 μm to 140 μm) was used as the powder of the iron-boron intermetallic compound (FeB), the powder was adjusted such that the weight ratio of FeTi and FeB was 6:4, and the powder was mixed by mixing with the V-type powder mixer for 30 minutes to obtain the mixed powder.

(ii) Step of Treating Mixed Powder Obtained in Step of (i) by Sintering to Obtain Iron-Based Alloy

In the step of (ii), the mixed powder obtained in the step of (i) was press-molded at a pressure of 8 t/cm², and the obtained press-molded product was sintered at 1280° C. for 60 minutes in a vacuum atmosphere, and then cooled at a rate of 15° C./m to obtain the iron-based alloy that was a cube having a side of 10 mm schematically shown in FIG. 3.

### EXAMPLE 1

The iron-based alloy was manufactured by the following steps of (i) and (ii).

(i) Step of Mixing Powder of Iron-Titanium Intermetallic Compound and Powder of Iron-Boron Intermetallic Compound to Obtain Mixed Powder

In the step of (i), the pulverized powder containing Fe: 57% by weight and Ti: 43% by weight (particle diameter (D50) by the laser diffraction and scattering method: 45 μm to 140 μm) was used as the powder of the iron-titanium intermetallic compound (FeTi), the pulverized powder containing Fe: 78% by weight and B: 22% by weight (particle diameter (D50) by the laser diffraction and scattering method: 45 μm to 140 μm) was used as the powder of the iron-boron intermetallic compound (FeB), the powder was adjusted such that the weight ratio of FeTi and FeB was 6:4, and the powder was mixed by mixing with the V-type powder mixer for 30 minutes to obtain the mixed powder.

(ii) Step of Treating Mixed Powder Obtained in Step of (i) by Lamination Molding Method Accompanied by Laser Irradiation (DED Method) to Obtain Iron-Based Alloy

In the step of (ii), the mixed powder obtained in the step of (i) was treated under the following conditions using the device shown in FIG. 2 to obtain the iron-based alloy that was the cube having a side of 10 mm schematically shown in FIG. 3. Note that SCM435 was used as the substrate, iron penetration from the substrate was observed in the obtained iron-based alloy.

DED condition

Laser output: 3000 W

Rate: 500 mm/min

One bead overlay: 100 mm

Cooling rate: 10,000 K/sec

### EXAMPLE 2

The iron-based alloy was manufactured by the following steps of (i) and (ii).

(i) Step of Mixing Powder of Iron-Titanium Intermetallic Compound and Powder of Iron-Boron Intermetallic Compound to Obtain Mixed Powder

In the step of (i), the pulverized powder containing Fe: 57% by weight and Ti: 43% by weight (particle diameter (D50) by the laser diffraction and scattering method: 45 μm to 140 μm) was used as the powder of the iron-titanium intermetallic compound (FeTi), the pulverized powder containing Fe: 78% by weight and B: 22% by weight (particle diameter (D50) by the laser diffraction and scattering method: 45 μm to 140 μm) was used as the powder of the iron-boron intermetallic compound (FeB), the powder was adjusted such that the weight ratio of FeTi and FeB was 1:1, and the powder was mixed by mixing with the V-type powder mixer for 30 minutes to obtain the mixed powder.

(ii) Step of Treating Mixed Powder Obtained in Step of (i) by Lamination Molding

Method Accompanied by Laser Irradiation (PBF Method) to Obtain Iron-Based Alloy

In the step of (ii), the mixed powder obtained in the step of (i) was treated under the following conditions using the device shown in FIG. 1 to obtain the iron-based alloy that was the cube having a side of 10 mm schematically shown in FIG. 3. Note that the Young's modulus of the iron-based alloy of Example 2 was 300 GPa.

PBF condition

Laser output: 900 W

Scanning rate: 1000 mm/sec

Beam diameter: 0.1 mm

Scanning pitch: 0.2 mm

Laminated thickness: 0.3 mm

Cooling rate: 10,000 K/sec or more

Here, the scanning pitch is a scanning interval of a laser beam, and the laminated thickness is a thickness per layer.

### EXAMPLE 3

The iron-based alloy was manufactured by the following steps of (i-2) and (ii).

(i-2) Step of Mixing Powder of Iron-Titanium Intermetallic Compound, Powder Iron-Boron Intermetallic Compound, and Iron-Based Powder to Obtain Mixed Powder

In the step of (i-2), the pulverized powder containing Fe: 57% by weight and Ti: 43% by weight (particle diameter (D50) by the laser diffraction and scattering method: 45 μm to 140 μm) was used as the powder of the iron-titanium intermetallic compound (FeTi), the pulverized powder containing Fe: 78% by weight and B: 22% by weight (particle diameter (D50) by the laser diffraction and scattering method: 45 μm to 140 μm) was used as the powder of the iron-boron intermetallic compound (FeB), water atomized powder (particle diameter (D50) by the laser diffraction and scattering method: 25 μm to 250 μm) was used as the iron (Fe)-based powder, the powder was adjusted such that the weight ratio of FeTi, FeB, and Fe was 1:1:1, and the powder was mixed by mixing with the V-type powder mixer for 30 minutes to obtain the mixed powder.

(ii) Step of Treating Mixed Powder Obtained in Step of (i-2) by Lamination Molding Method Accompanied by Laser Irradiation (PBF Method) to Obtain Iron-Based Alloy

In the step of (ii), the mixed powder obtained in the step of (i-2) was treated under the following conditions using the device shown in FIG. 1 to obtain the iron-based alloy that was the cube having a side of 10 mm schematically shown in FIG. 3.

Note that the Young's modulus of the iron-based alloy of Example 3 was 280 GPa.

PBF condition

Laser output: 900 W

Scanning rate: 1000 mm/sec

Beam diameter: 0.1 mm

Scanning pitch: 0.2 mm

Laminated thickness: 0.3 mm

Cooling rate: 10,000 K/sec or more

Here, the scanning pitch is the scanning interval of the laser beam, and the laminated thickness is the thickness per layer.

2. Evaluation of SEM

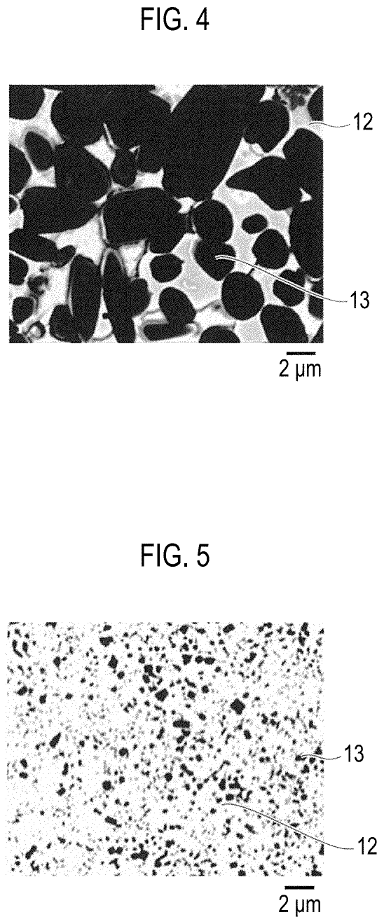

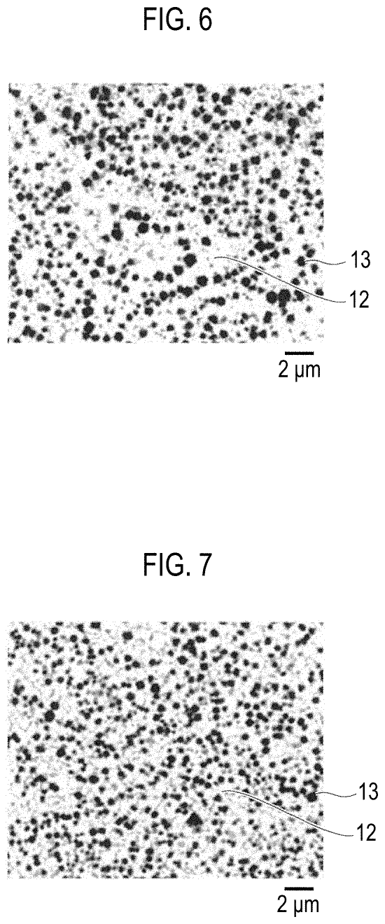

SEM images of the iron-based alloys obtained in Comparative Example 1 and Examples 1 to 3 were captured. The results were shown in FIGS. 4 to 7. FIG. 4 is the SEM image of Comparative Example 1, FIG. 5 is the SEM image of Example 1, FIG. 6 is the SEM image of Example 2, and FIG. 7 is the SEM image of Example 3.

In FIGS. 4 to 7, 12 (relatively white portion) indicates the matrix made of the iron or the ferroalloy, and 13 (relatively black portion) indicates the titanium boride. From FIG. 4, it was found that the iron-based alloy manufactured by sintering in Comparative Example 1 had large titanium boride. On the other hand, from FIGS. 5 to 7, it was found that the iron-based alloys manufactured by the lamination molding method in

Examples 1 to 3 had titanium boride that was small and uniformly dispersed in the matrix. Further, from the comparison between FIG. 6 and FIG. 7, it was found that, by further mixing the iron-based powder with the mixed powder, the average particle diameter of the titanium boride can be further reduced and the dispersibility of the titanium boride can be improved.

3. Evaluation of Machinability

The iron-based alloys obtained in Comparative Example 1 and Examples 1 to 3 were cut with a general-purpose grindstone cutter (wet type). The iron-based alloy of Comparative Example 1 had a large resistance and was difficult to cut, whereas the iron-based alloys of Examples 1 to 3 had a small resistance and could be cut without any problem.

What is claimed is:

1. A high-rigidity iron-based alloy comprising:
a matrix made of iron or a ferroalloy; and
titanium boride dispersed in the matrix,
wherein an equivalent circle average particle diameter by an SEM image of the titanium boride is 0.2 μm to 0.6 μm.

2. The high-rigidity iron-based alloy according to claim 1, wherein the equivalent circle average particle diameter by the SEM image of the titanium boride is 0.2 μm to 0.4 μm.

3. A method of manufacturing a high-rigidity iron-based alloy, the method comprising:
(i) a step of mixing powder of an iron-titanium intermetallic compound and powder of an iron-boron intermetallic compound to obtain mixed powder; and
(ii) a step of treating the mixed powder obtained in the step of (i) by a lamination molding method accompanied by laser irradiation to obtain a high-rigidity iron-based alloy.

4. The method according to claim 3, wherein the step of (i) includes (i-2) a step of mixing the powder of the iron-titanium intermetallic compound, the powder of the iron-boron intermetallic compound, and iron-based powder to obtain mixed powder.

5. The method according to claim 3, wherein, in the step of (ii), a cooling rate during lamination molding is 10,000 K/sec or more.

6. The method according to claim 3, wherein, in the step of (ii), the lamination molding method accompanied by the laser irradiation is a PBF method.

7. The method according to claim 3, wherein, in the step of (ii),
the lamination molding method accompanied by the laser irradiation is a DED method, and
iron from a substrate for manufacturing the high-rigidity iron-based alloy is penetrated into an iron-based alloy.
